(19) United States
(12) Patent Application Publication
(10) Pub. No.: US 2009/0147440 A1
(43) Pub. Date: Jun. 11, 2009

(54) LOW INDUCTANCE, HIGH RATING CAPACITOR DEVICES

(75) Inventors: Stanley P. Cygan, Olean, NY (US); Andrew P. Ritter, Surfside Beach, SC (US); John L. Galvagni, Surfside Beach, SC (US)

Correspondence Address: DORITY & MANNING, P.A., POST OFFICE BOX 1449, GREENVILLE, SC, 29602-1449, US

(73) Assignee: AVX Corporation, Myrtle Beach, SC (US)

(21) Appl. No.: 12/329,129

(22) Filed: Dec. 5, 2008

Related U.S. Application Data
(60) Provisional application No. 61/007,182, filed on Dec. 11, 2007.

(51) Int. Cl. H01G 4/228

(52) U.S. Cl. 361/306.3; 29/25.41

(57) ABSTRACT

Methodologies and structures are disclosed for providing multilayer electronic devices having low inductance and high ratings, such as for capacitor devices for uses involving faster pulsing and higher currents. Plural layer devices are constructed for relatively lowered inductance by relatively altering typical orientation of capacitors such that their electrodes are placed into a vertical position relative to an associated circuit board. Optionally, individual leads may be formed so that the resulting structure can be used as an array. Internal electrodes may be arranged for reducing current loops for associated circuits on a circuit board, to correspondingly reduce the associated inductance of the circuit board mounted device. Leads associated with such devices may have added tab-like structures which serve to more precisely place the lead, to improve the lead to capacitor strength, and to promote lower resistance and inductance. Disclosed designs for reducing associated inductance may be practiced in conjunction with various electric devices, including capacitors, resistors, inductors, or varistors.

### PRIORITY CLAIM

This application claims priority under 35 U.S.C. 119(e) of U.S. Provisional Patent Application Ser. No. 61/007,182 filed Dec. 11, 2007, entitled “LOW INDUCTANCE, HIGH RATING CAPACITOR DEVICES,” which is hereby incorporated by reference in its entirety for all purposes.

### FIELD OF THE INVENTION

The present subject matter generally concerns improved component formation for multilayer electronic components. More particularly, the present subject matter relates to methodologies and structures for providing low inductance capacitor devices which have high ratings, such as for use in high current and/or high power circuit-based technologies.

### BACKGROUND OF THE INVENTION

Many modern electronic components are packaged as monolithic devices, and may comprise a single component or multiple components within a single chip package. One specific example of such a monolithic device is a multilayer capacitor or capacitor array, and of particular interest with respect to the disclosed technology are multilayer capacitors with interdigitated internal electrode layers. Present FIGS. 1a through 1e illustrate a so-called radial-leaded design of ceramic capacitors, as has been used previously in recent decades. Such a device may be typically used in circuits where leaded parts or devices are placed in the holes of printed circuit boards. While previously common, use of such designs is now often supplanted with so-called MultiLayer Capacitor (MLC) chips.

Examples of multilayer capacitors that include features of interdigitated capacitor (IDC) technology can be found in U.S. Pat. No. 4,831,494 (Arnold et al), U.S. Pat. No. 5,880,925 (DuPré et al.) and U.S. Pat. No. 6,243,253 B1 (DuPré et al.). Other monolithic electronic components correspond to devices that integrate multiple passive components into a single chip structure. Such an integrated passive component may provide a selected combination of resistors, capacitors, inductors and/or other passive components that are formed in a multilayered configuration and packaged as a monolithic electronic device.

Additional background references that address methodology for forming multilayer ceramic devices include U.S. Pat. No. 4,811,164 (Ling et al.), U.S. Pat. No. 4,266,265 (Maher), U.S. Pat. No. 4,241,378 (Dorrian), and U.S. Pat. No. 3,988,498 (Maher).

As switching speeds increase and pulse rise times decrease in electronic circuit applications, the need to reduce inductance becomes a serious limitation for improved system performance. Even the decoupling capacitors, that act as a local energy source, can generate unacceptable voltage spikes: V=L (di/dt). Thus, in high speed circuits where di/dt can be quite large, the size of the potential voltage spikes can only be reduced by reducing the inductance value L.

The prior art includes several strategies for reducing equivalent series inductance, or ESL, of chip capacitors compared to standard multilayer chip capacitors. A first exemplary strategy involves reverse geometry termination, such as employed in low inductance chip capacitor (LICC) designs such as manufactured and sold by AVX Corporation. In LICCs, electrodes are terminated on the long side of a chip instead of the short side. Since the total inductance of a chip capacitor is determined in part by its length to width ratio, LICC reverse geometry termination results in a reduction in inductance by as much as a factor of six from conventional MultiLayer Capacitor (MLC) chips.

Interdigitated capacitors (IDCs) incorporate a second known strategy for reducing capacitor inductance. IDCs incorporate electrodes having a main portion and multiple tab portions that connect to respective terminations formed on the capacitor periphery. Multiple such terminations can help reduce the parasitic inductance of a device. Examples of interdigitated capacitors are disclosed in U.S. Pat. No. 6,243,253 (DuPre et al.)

A still further known technology utilized for reduction in capacitor inductance involves designing alternative current paths to minimize the mutual inductance factor of capacitor electrodes. A low inductance chip array (LICA) product, such as manufactured and sold by AVX Corporation, minimizes mutual inductance by configuring a ball grid array multilayer capacitor such that the charging current flowing out of a positive plate returns in the opposite direction along an adjacent negative plate. Utilization of LICA technology achieves low inductance values by low aspect ratio of the electrodes, an arrangement of electrode tabs so as to cancel inductance and vertical aspect of the electrodes to the mounting surface.

Additional references that incorporate adjacent electrodes having reverse current paths used to minimize inductance include U.S. Published Patent Application No. 2005/0047059 (Togashi et al.) and U.S. Pat. No. 6,292,351 (Ahiko et al.) Both such references also utilize a vertical aspect of electrodes relative to a mounting surface. Additional references that disclose electrodes for use in a vertically-oriented position include U.S. Pat. No. 5,517,385 (Galvagni et al.), U.S. Pat. No. 4,831,494 (Arnold et al.) and U.S. Pat. No. 6,885,544 (Kim et al.)

A known reference that discloses features aimed to reduce inductance in an integrated circuit package that includes, in part, a capacitive device is U.S. Pat. No. 6,483,692 (Figueroa et al.). Such reference recognizes that inductance relates to circuit board “loop area” or the electrical distance that current must follow. It is desirable in Figeuroa et al. to minimize such loop area, thus reducing the inductance levels. Extended surface lands are also provided in Figueroa et al., providing a larger surface area that is said to result in more reliable connections characterized by reduced inductance and resistance levels.

U.S. Pat. No. 6,661,640 (Togashi) also discloses features for reducing ESL of a decoupling capacitor by maximizing the surface area of device terminations. U.S. Pat. No. 6,917,510 (Prymak) discloses a capacitor embodiment with terminal extensions formed to result in a narrow gap between the electrodes. The end electrodes of U.S. Pat. No. 6,822,847 (Devoe et al.) also cover all but a thin separation line at a central portion of the capacitor body.

Still further known references that include features for reducing component inductance correspond to U.S. Pat. No. 6,757,152 (Galvagni et al.) and U.S. Pat. No. 6,606,237 (Naito et al.), in which conductive vias are utilized to form generally low inductance connections to upper electrodes in a multilayer capacitor.

Additional background references that may address certain aspects of low-inductance multilayer electronic devices include U.S. Pat. No. 6,576,497 (Ahiko et al.) and U.S. Pat. No. 3,444,436 (Coda) as well as U.S. Published Patent Application No. 2004/0184202 (Togashi et al.).

While the needs and desires for lower inductance features has previously arisen and been addressed in certain technological contexts, such needs and desires have arisen in yet other contexts. In particular, in some high-current and/or high power circuits, relatively massive (i.e., high value or rating) capacitors are required. One such example is in conjunction with so-called Switch Mode Power Supplies (SMPS). In the present context, such capacitors under discussion may be, for example, about a cubic inch in volume. Typical capacitances of such devices may be in a range of about 10 to about 100 microfarads, and rated voltages may be in a range from about 50 volts to over 500 volts.

Present FIGS. 2a through 2d illustrate an example of such a so-called Switch Mode Power Supply (SMPS) related device. The name itself has come from the more common usage of such design in recent years after it was introduced. In the illustrations of present FIGS. 2a through 2d, which are discussed in greater detail below, certain of the drawings omit well-known horizontal bars and sprockets allowing for handling of the parts, in order to more simplistically represent the subject matter as background.

In recent years, such products have been commercialized using standard MLC technology, often with Mid-K dielectrics (constants about 2500) and precious metal electrodes. Such format has been similar to multlayer chip capacitors, usually a number stacked up, and soldered to heavy lead-frames to be able to be combined and mounted by the customer.

More recently, however, marketplace needs for ever faster pulsing and for higher currents have led to inductance-related concerns, much as in the smaller chip devices meant for decoupling computer lines.

While various aspects and alternative features are known in the field of multilayer electronic components and related methods for manufacture, no one design has emerged that generally addresses all of the issues as discussed herein. The disclosures of all the foregoing United States patents and published patent applications, and those otherwise referenced herein below, are hereby fully incorporated into this application for all purposes by virtue of present reference thereto.

### BRIEF SUMMARY OF THE INVENTION

In view of the recognized features encountered in the prior art and addressed by the present subject matter, improved methodologies and structures have been developed for producing multilayer electronic components. More particularly, the present subject matter relates to methodologies and structures for providing low inductance capacitor devices which have high ratings, such as for use in high current and/or high power circuit-based technologies.

In exemplary configurations, multilayer devices may be produced having differing electrical characteristics, such as varying degrees of reduced inductance.

According to additional aspects of certain embodiments of the present subject matter, multilayer device configurations may be produced resulting in particular lead and/or termination configurations as useful for various applications.

According to further aspects of certain embodiments of the present subject matter, multilayer device configurations may be produced with different devices other than just capacitors, such as including resistors, inductors, or varistors. One exemplary such configuration may insert a varistor in parallel with plural capacitors, such as to provide bulk capacitance having overvoltage protection.

One present exemplary embodiment relates to a low inductance multilayer electronic component configured for mounting on a circuit board having an associated circuit. Such embodiment preferably may include a plurality of first and second electrode layers, first and second termination layers, and a pair of lead frame elements. Preferably for such plurality of first electrode layers, each first electrode layer respectively has a first conductive layer extending to at least a portion of one edge of each such respective first electrode layer. Such plurality of second electrode layers are preferably alternately stacked with such plurality of first electrode layers, with each second electrode layer respectively having a second conductive layer extending to at least a portion of one edge of each such respective second electrode layer. Such first conductive termination layer preferably covers a portion of such at least one edge of each such respective first electrode layer and electrically connects such first conductive layer of each of such plurality of first electrode layers. Such second conductive termination layer preferably covers a portion of such at least one edge of each such respective second electrode layer and electrically connects such second conductive layer of each of such plurality of second electrode layers.

In the foregoing exemplary embodiment, preferably such pair of lead frame elements are respectively connected structurally and electrically with such first and second conductive termination layers, and configured so that such first and second electrode layers are in a vertical position relative to an associated circuit board, whereby a minimum current loop area is formed with such plurality of first and second electrode layers and the associated circuit of an associated circuit board, so as correspondingly reduce inductance of such multilayer electronic component.

In certain exemplary configurations of the foregoing exemplary component, such plurality of first and second electrode layers may be configured so as to form such component as one of a capacitor, resistor, varistor, and inductor.

In still other exemplary embodiments, such plurality of first and second electrode layers may include respective dielectric layers and may be configured in respective sets so as to form an array of respective capacitors. Optionally, in such other exemplary embodiments, a plurality of respective first and second conductive termination layers may be respectively provided, associated with such respective capacitors, while a plurality of separators may be provided between such respective capacitors, for electrically isolating such respective capacitors, wherein such pair of lead frame elements may be respectively provided for including individual leads associated in pairs with such respective capacitors.

In other alternatives of the foregoing exemplary embodiments, such pair of lead frame elements may respectively comprise predetermined shapes, adapted for particular uses of such component. Still further alternatively, such pair of lead frame elements may respectively include tabs which comprise predetermined shapes and which establish designated contact areas for such termination layers.

The foregoing exemplary embodiments of a present low inductance multilayer electronic component may be practiced further in combination with a circuit board having an associated circuit, with such pair of lead frame elements secured to such circuit board, and with such termination layers electrically connected with such associated circuit of such circuit board.

In other present alternatives, such first and second conductive termination layers may be configured so as to leave exposed at least edges and a side of such electronic component, to facilitate handling and positioning thereof relative to other components.

In other alternative embodiments of the foregoing low inductance multilayer electronic components, each of such plurality of first electrode layers respectively may comprise a first dielectric layer having first and second surfaces thereof bounded by four edges and with each of such respective first conductive layers thereof covering a portion of such first surface of such first dielectric layer and extending to at least a portion of one edge of such first dielectric layer; and with each of such plurality of second electrode layers respectively comprising a second dielectric layer having first and second surfaces thereof bounded by four edges and with each of such respective second conductive layers thereof covering a portion of such first surface of such second dielectric layer and extending to at least a portion of one edge of such second dielectric layer.

Another present exemplary embodiment relates to a low inductance multilayer electronic capacitor, configured for mounting on a circuit board having an associated circuit, comprising a plurality of first electrode layers, with each first electrode layer comprising a first dielectric layer having first and second surfaces thereof and a first conductive layer covering a portion of such first surface of such first dielectric layer and extending to at least a portion of one edge of such first dielectric layer; a plurality of second electrode layers alternately stacked with such plurality of first electrode layers, with each second electrode layer comprising a second dielectric layer having first and second surfaces thereof and a second conductive layer covering a portion of such first surface of such second dielectric layer and extending to at least a portion of one edge of such second dielectric layer, the second conductive layer formed as a mirror image of the first conductive layer; a first conductive termination layer covering a portion of such at least one edge of such first electrode layer and electrically connecting such first conductive layer of each of such plurality of first electrode layers; a second conductive termination layer covering a portion of such at least one edge of such second electrode layer and electrically connecting such second conductive layer of each of such plurality of second electrode layers; and a pair of lead frame elements respectively connected structurally and electrically with such first and second conductive termination layers, and configured so that such first and second electrode layers are in a vertical position relative to an associated circuit board. Advantageously, with the foregoing exemplary arrangement, a minimum current loop area is formed with such plurality of first and second electrode layers and the associated circuit of an associated circuit board, so as correspondingly reduce inductance of such multilayer electronic capacitor.

In alternative embodiments of the foregoing present exemplary low inductance multilayer electronic device, such plurality of first and second electrode layers may be configured in respective sets so as to form an array of respective capacitors; and such device may further comprise a plurality of respective first and second conductive termination layers, respectively associated with such respective capacitors; and a plurality of separators between such respective capacitors, for electrically isolating such respective capacitors, with such pair of lead frame elements respectively including individual leads associated in pairs with such respective capacitors.

Per another present exemplary low inductance multicomponent interdigitated electronic capacitor, configured for mounting on a circuit board having an associated circuit, a plurality of first electrode layers may be provided, each first electrode layer comprising a first dielectric layer having first and second surfaces thereof and a first conductive layer covering a portion of such first surface of such first dielectric layer and extending in a plurality of first termination tabs to at least one edge of such first dielectric layer. Also, a plurality of second electrode layers may be alternately stacked with such plurality of first electrode layers, each second electrode layer comprising a second dielectric layer having first and second surfaces thereof and a second conductive layer covering a portion of such first surface of such second dielectric layer and extending in a plurality of second termination tabs to at least one edge of such second dielectric layer, the second conductive layer formed as a mirror image of the first conductive layer. Still further, at least two respective sets of such plurality of first and second electrode layers may be provided, configured for forming respective interdigitated capacitor components, along with a set of first conductive termination layers covering respectively such first termination tabs of such at least one edge of such first electrode layer and electrically connecting such first conductive layer of each of such plurality of first electrode layers, and a set of second conductive termination layers covering respectively such second termination tabs of such at least one edge of such second electrode layer and electrically connecting such second conductive layer of each of such plurality of second electrode layers. Still further, a pair of respective sets of lead frame elements may be respectively connected structurally and electrically with such first and second sets of conductive termination layers, and configured so that such first and second electrode layers are in a parallel position relative to an associated circuit board, each of such respective lead frame elements having a lead tab directly contacting and supporting such respective conductive termination layers, whereby a low resistance and low inductance connection is formed with such interdigitated capacitor components.

As understood from the totality of the present disclosure, the present subject matter equally encompasses corresponding and related methodology. One exemplary present embodiment relates to methodology for making a low inductance multilayer electronic component configured for mounting on a circuit board having an associated circuit. Such methodology preferably comprises providing a plurality of first electrode layers, each first electrode layer respectively having a first conductive layer extending to at least a portion of one edge of each such respective first electrode layer; providing a plurality of second electrode layers alternately stacked with such plurality of first electrode layers, each second electrode layer respectively having a second conductive layer extending to at least a portion of one edge of each such respective second electrode layer; covering a portion of such at least one edge of each such respective first electrode layer with a first conductive termination layer which electrically connects such first conductive layer of each of such plurality of first electrode layers; covering a portion of such at least one edge of each such respective second electrode layer with a second conductive termination layer which electrically connects such second conductive layer of each of such plurality of second electrode layers; and providing a pair of lead frame elements respectively connected structurally and electrically with such first and second conductive termination layers, and configured so that such first and second electrode layers are in a vertical position relative to an associated circuit board, thereby forming a minimum current loop area with such plurality of first and second electrode layers and the associated circuit of an associated circuit board, so as correspondingly reduce inductance of such multilayer electronic component.

Alternatives of the foregoing present exemplary methodology may include selectively configuring such plurality of first and second electrode layers so as to form such component as one of a capacitor, resistor, varistor, and inductor. Still other present alternatives may include providing such plurality of first and second electrode layers with respective dielectric layers; configuring such dielectric layers in respective sets so as to form an array of respective capacitors; providing a plurality of respective first and second conductive termination layers, respectively associated with such respective capacitors; providing a plurality of separators between such respective capacitors, for electrically isolating such respective capacitors; and providing such pair of lead frame elements respectively with individual leads associated in pairs with such respective capacitors.

Alternatively, present methodologies may additionally include providing a circuit board having an associated circuit; and securing such pair of lead frame elements to such circuit board, with such termination layers electrically connected with such associated circuit of such circuit board. Yet, per other present alternatives, the step of providing a pair of lead frame elements respectively connected structurally and electrically with such first and second conductive termination layers may include one of soldering, brazing, and bonding with conductive epoxy such lead frame elements to such termination layers. Further alternatively, the steps of covering respective electrode layers with termination layers may include electroless copper deposition of such termination layers.

Another present exemplary methodology for making a low inductance multilayer electronic capacitor, configured for mounting on a circuit board having an associated circuit, may comprise providing a plurality of first electrode layers, each first electrode layer comprising a first dielectric layer having first and second surfaces thereof and a first conductive layer covering a portion of such first surface of such first dielectric layer and extending to at least a portion of one edge of such first dielectric layer; providing a plurality of second electrode layers alternately stacked with such plurality of first electrode layers, each second electrode layer comprising a second dielectric layer having first and second surfaces thereof and a second conductive layer covering a portion of such first surface of such second dielectric layer and extending to at least a portion of one edge of such second dielectric layer, the second conductive layer formed as a mirror image of the first conductive layer; covering a portion of such at least one edge of such first electrode layer with a first conductive termination layer which electrically connects such first conductive layer of each of such plurality of first electrode layers; covering a portion of such at least one edge of such second electrode layer with a second conductive termination layer which electrically connects such second conductive layer of each of such plurality of second electrode layers; and providing a pair of lead frame elements respectively connected structurally and electrically with such first and second conductive termination layers, and configured so that such first and second electrode layers are in a vertical position relative to an associated circuit board, thereby forming a minimum current loop area with such plurality of first and second electrode layers and the associated circuit of an associated circuit board, so as correspondingly reduce inductance of such multilayer electronic component.

Present alternatives of the foregoing methodology may further include providing each of such pair of lead frame elements respectively with a plurality of holes; and securing bonding material in such lead frame element holes.

Additional objects and advantages of the present subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments and uses of the present subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the Figures or stated in the detailed description of such Figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application.

Additionally it should be appreciated that, while the examples given herein relate primarily to structures and methodologies for the production of particular capacitor devices where electrode layers are printed on support material corresponding to various dielectric materials, such is not limiting to the disclosure as the subject matter disclosed herein may also be applied to produce other device types by providing alternate selections for the dielectric materials selected for use in the illustrated and discussed capacitor examples. As an example, a varistor or a resistor device may be produced using the methodologies and structural configurations of the present subject matter by selection of appropriate inter-electrode support materials. Those of ordinary skill in the art will better appreciate the features and aspects of such embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended Figures, in which:

FIGS. 1a through 1e, respectively, illustrate different aspects and views of an example of a prior art so-called radial-leaded design of ceramic capacitors, as has been used previously in recent decades (typically such as in circuits where leaded parts or devices are placed in the holes of printed circuit boards), with FIG. 1a illustrating an exploded generally side and end perspective view of the major components of such exemplary device, with FIG. 1b illustrating an assembled generally side and end perspective view of such major components thereof, with FIG. 1c illustrating a cross-sectional view of the illustrated assembled device of FIG. 1b taken along section line A-A′ thereof, with FIG. 1d illustrating exploded generally side and end perspective view of layers of the main component of such exemplary device, and with FIG. 1e illustrating the main component of such exemplary device in partial cutaway in a generally side and end perspective view;

FIGS. 2a through 2d, respectively, illustrate different aspects and views of an example of a prior art so-called Switch Mode Power Supply (SMPS) related device, with FIG. 2a illustrating an exploded generally side and end perspective view of the major components of such exemplary device, with FIG. 2b illustrating an assembled generally side and end perspective view of such major components thereof in an intermediate stage, with FIG. 2c illustrating a cross-sectional view of the illustrated assembled device of FIG. 2b taken along section line B-B′ thereof, and with FIG. 2d illustrating a completed example of such SMPS related device in a generally side and end perspective view;

FIGS. 3a through 3d, respectively, illustrate different aspects and views of an exemplary embodiment of a low inductance, high rating device in accordance with the present subject matter, with FIG. 3a illustrating an exploded generally side and end perspective view of the major components of such exemplary embodiment, with FIG. 3b illustrating an assembled generally side and end perspective view of such major components, with FIG. 3c illustrating a cross-sectional view of the illustrated assembled device of FIG. 3b taken along section line C-C′ thereof, and with FIG. 3d illustrating various sides views of such a completed example of such exemplary embodiment, with alternative lead configurations thereof which may be practiced in accordance with the present subject matter;

FIGS. 4a through 4e, respectively, illustrate different aspects and views of another exemplary embodiment of a low inductance, high rating device in accordance with the present subject matter, with FIG. 4a illustrating an exploded generally side and end perspective view of the major components of such exemplary embodiment, with FIG. 4b illustrating an assembled generally side and end perspective view of such major components, with FIG. 4c illustrating a cross-sectional view of the illustrated assembled device of FIG. 4b taken along section line D-D′ thereof, with FIG. 4d illustrating a generally side and end perspective view of the assembled parts of present FIG. 4b electrically joined, and with FIG. 4e illustrating a generally side and end perspective view of a completed example of a variation of such exemplary embodiment, configured with respective individual leads;

FIG. 5a illustrates a generally side and end perspective view of two exemplary capacitor devices mounted on an exemplary circuit board in a generally known configuration;

FIG. 5b illustrates a planar side view of respective exemplary internal electrode designs in accordance with the present subject matter and applicable to present FIG. 5a;

FIG. 5c illustrates in partial shadow view a generally side and end perspective view of an exemplary arrangement of internal electrodes, such as represented in present FIG. 5b, in accordance with the present subject matter;

FIG. 5d illustrates a generally side and end perspective view of the assembled configuration of present FIG. 5c after such assembled device has been sintered in accordance with the present subject matter;

FIG. 5e illustrates a generally side and end perspective view of a completed exemplary embodiment of the subject matter of present FIGS. 5b through 5d in accordance with the present subject matter;

FIGS. 6a through 6f, respectively, illustrate different aspects and views of another exemplary embodiment of a low inductance, high rating device in accordance with the present subject matter, with FIG. 6a illustrating an exploded generally side and end perspective view of the major components of such exemplary embodiment, with FIG. 6b illustrating an assembled generally side and end perspective view of such major components, with FIG. 6c illustrating a cross-sectional view of the illustrated assembled device of FIG. 6b taken along section line E-E′ thereof, with FIG. 6d illustrating a cross-sectional view of an assembled device in accordance with the present subject matter similar to the view of present FIG. 6c but illustrating a present alternative lead configuration thereof, with FIG. 6e illustrating an enlarged portion of particular exemplary features shared in common by the alternative configurations of present FIGS. 6c and 6d, and with FIG. 6f illustrating a generally side and end perspective view of a completed example of such exemplary embodiment; and

FIGS. 7a through 7e, respectively, illustrate different aspects and views of still another exemplary embodiment of a low inductance device in accordance with the present subject matter, with FIG. 7a illustrating an exploded generally side and end perspective view of the major components of such exemplary embodiment, with FIG. 7b illustrating an assembled generally side and end perspective view of such major components, with FIG. 7c illustrating a slightly skewed, perspective view of the internal electrode configuration thereof, with FIG. 7d illustrating a cross-sectional view of the illustrated assembled device of FIG. 7b taken along section line F-F′ thereof, and with FIG. 7e illustrating a generally side and end perspective view of a nearly completed part of such exemplary embodiment.

Repeat use of reference characters throughout the present specification and appended drawings is intended to represent same or analogous features, elements, or steps of the present subject matter.

### DETAILED DESCRIPTION OF THE PREFERRED EMBODIMENTS

As discussed in the Summary of the Invention section, the present subject matter is particularly concerned with improved methodologies for producing multilayer electronic devices and resulting devices corresponding therewith. Selected combinations of aspects of the disclosed technology correspond to a plurality of different embodiments of the present subject matter. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

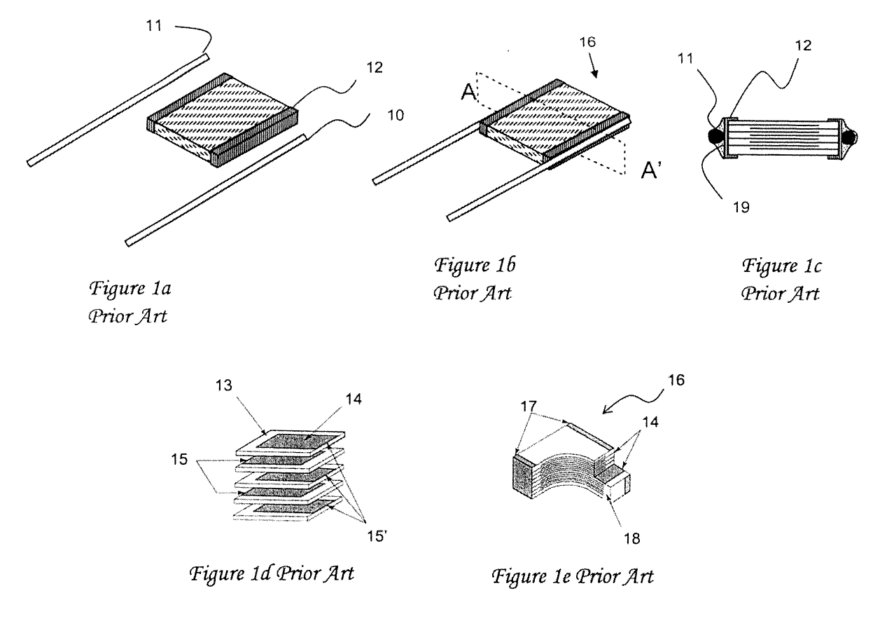

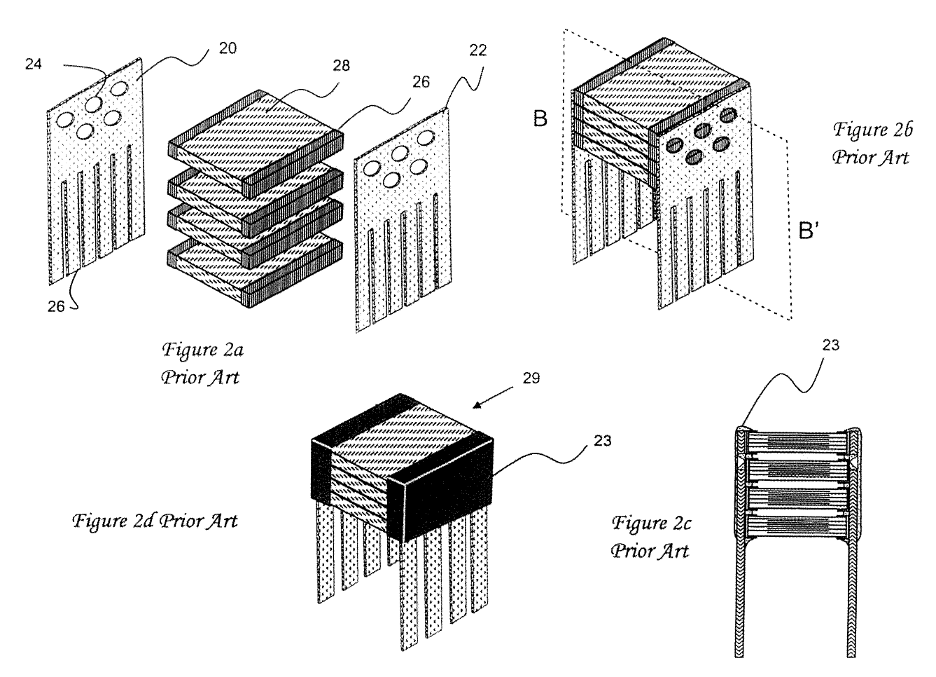

Reference will be made in detail to the presently preferred embodiments of the subject multilayer device. However, initially, further description is provided with reference to prior art FIGS. 1a through 2d.

Referring now to the drawings, FIGS. 1a through 1e illustrate a so-called radial-leaded design of ceramic capacitors, as has been typically used in circuits where leaded parts or devices are placed in the holes of printed circuit boards. FIG. 1a illustrates an exploded generally side and end perspective view of the major components of such exemplary device. Leads 10 and 11 are respectively attached to the MultiLayer Capacitor (MLC) 12. FIG. 1b illustrates an assembled generally side and end perspective view of such major components of such exemplary MLC device.

The construction of such an MLC is well known, but is shown in FIGS. 1c through 1e for completeness. FIG. 1c illustrates a cross-sectional view of the illustrated assembled device of FIG. 1b taken along section line A-A′ thereof. FIG. 1d illustrates an exploded generally side and end perspective view of layers of the main component of such exemplary device, while FIG. 1e illustrates the main component of such exemplary device in partial cutaway in a generally side and end perspective view. As collectively illustrated, ceramic layers 13 are respectively printed with an electrode 14 such that only one edge is exposed to the outside, as represented respectively at edges 15 and 15′. The layers are stacked and fired (sintered) so as to form the completed MLC generally 16. Terminations 17 are provided for external attachment, with margins 18 included to provide physical and electrical isolation for each respective electrode. With the application of such terminations, as well understood by those of ordinary skill in the art, alternate electrode layers are coupled together to produce a capacitor. In such known configuration, electrode layers are generally produced through the use of separated screen printing masks.

The MLC device generally 16 is positioned as shown in FIG. 1b, and soldered in place, usually with a high temperature solder. For example, a solder such as having a melting point of about 280° C. may often be used so that the ultimate user can solder with eutectic solders in the range of 200° C. without the leads falling off. In the FIG. 1c cross-sectional view through the plane represented by section line A-A′ of FIG. 1b, the resulting configuration has exemplary lead 11 attached to the MLC termination 12 with solder 19.

While such an exemplary radial leaded part served well for many years, use of such configuration diminished generally as industry switched to surface-mounted systems. One exception, however, was in conjunction with the high-current systems, where the resistances of the popular Printed Wiring Board's (PWB's) were not ideal. Other reasons included the fact that such typically larger parts usually have a very different thermal coefficient of expansion from the epoxy-glass board, and the Distance from Neutral Point (DNP-a measure of the major length between fixed solder joints) was large enough that some cracking of the ceramic could be expected. Another reason was the flexing of the PWB could create broken solder joints, or broken parts. A third reason was that sometimes there was a need to dissipate relatively more heat.

As the need for such larger capacitors became evident, some standard approaches emerged. It was not practical, or cost-effective, to build such a large capacitor in a single package. Accordingly, industry at that time opted to stack smaller parts, and to bond them together.

Present FIGS. 2a through 2d illustrate an example of a so-called Switch Mode Power Supply (SMPS) related device, though with various well-known horizontal bars and sprockets (for handling of the parts) omitted from the illustrations, in order to more clearly otherwise represent such prior art subject matter as background. FIG. 2a shows the major component parts of such exemplary background device, having lead frames 20 and 22. As notes, the present illustrations of such leads do not show the sub- or super-structure of the lead frames. One of the key features of such sort of lead frames is the provision of through holes 24 to assist in soldering and to provide relatively greater component strength. The main components or parts are then held together in a soldering jig, in the relative positions shown in FIG. 2b. The cross-sectional view through the virtual plane B-B′ of FIG. 2b, as shown in FIG. 2c, is how such part appears once it is soldered. FIG. 2d is representative of the exemplary completed device 29, with solder 23 illustrated, which unitizes the package.

The above-noted problems with such prior art devices were not recognized until the industry started using faster pulsing and using higher currents. As part of the presently disclosed subject matter, an exemplary aspect in beneficially reducing the subject inductance is to alter the orientation of the capacitors. Per the presently disclosed subject matter, that for example may include placing the electrodes in a vertical position relative to the associated circuit board, which beneficially results in reducing a subject current loop, as otherwise discussed herein.

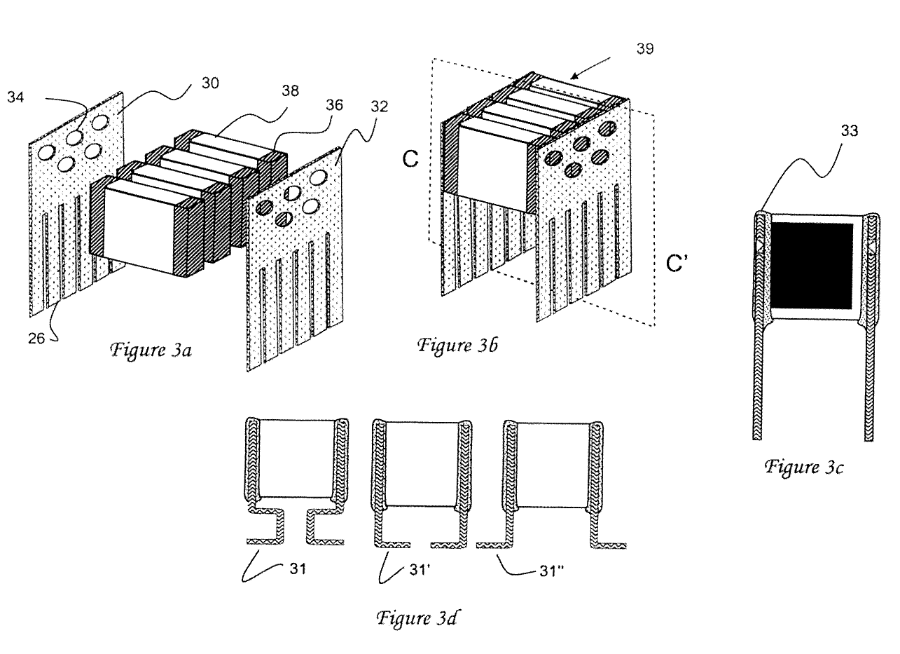

FIGS. 3a through 3d illustrate and represent a first exemplary embodiment of the present subject matter, inclusive of alternative lead configurations thereof which may be practiced in accordance with the present subject matter. Such exemplary embodiment subject matter provides lowering of the inductance of an SMPS related type capacitor by altering the positioning of the part, so that the electrodes are perpendicular to the circuit board, all in accordance with the present subject matter.

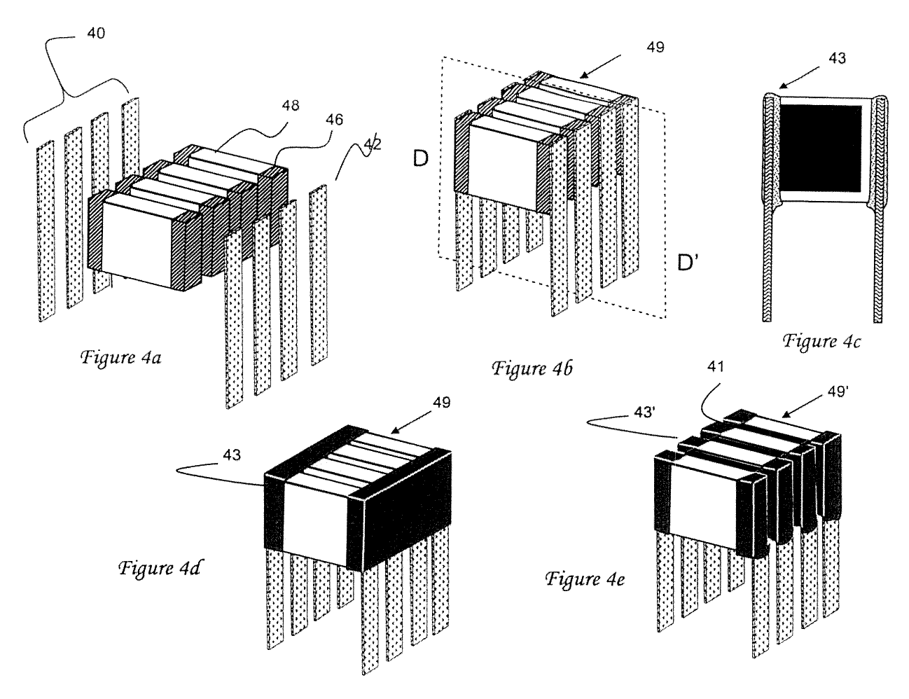

FIGS. 4a through 4e illustrate another present exemplary embodiment of the present subject matter, and relatively further reducing the subject inductance. Such embodiment incorporates separation of leads such that respective capacitors may be individually accessed per the present subject matter, as in a cap array, or such that they may be combined so as to produce a relatively larger capacitor.

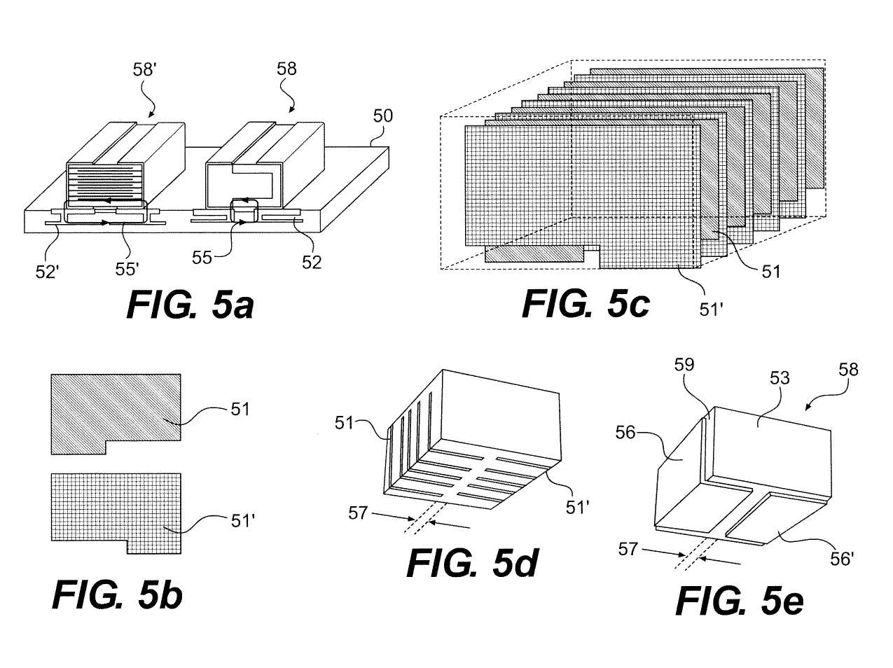

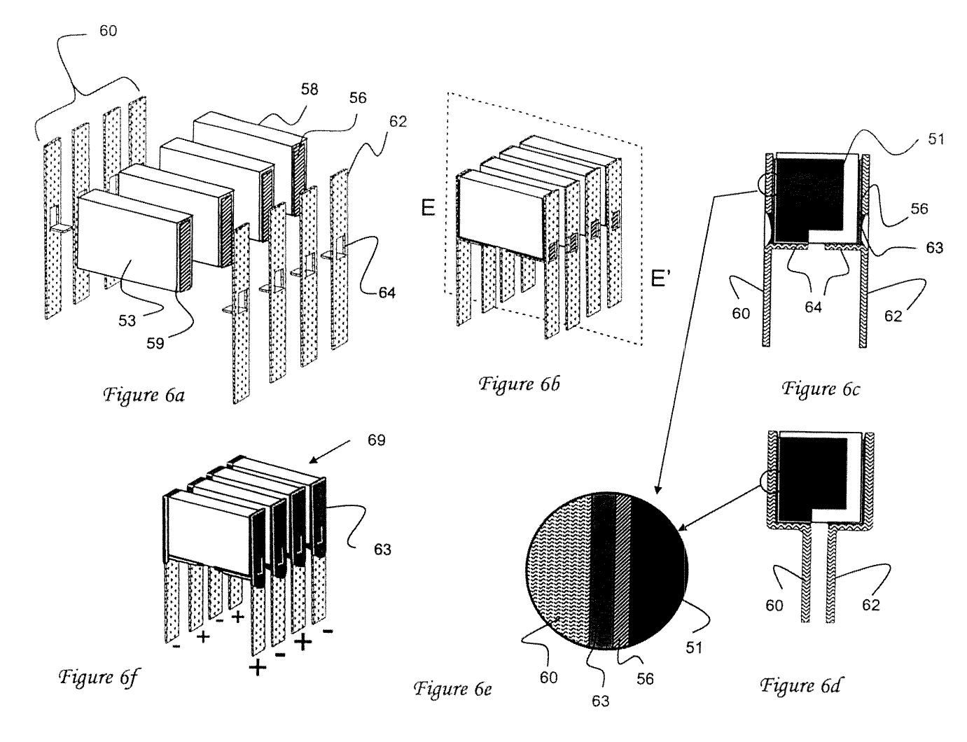

Disclosure presented herewith in conjunction with present FIGS. 5a through 5e relates to another present exemplary low inductance device configuration in accordance with the present subject matter. Mounting of leads on such a device can be to some extent counterproductive to lowering inductance, since it can tend to add inductance. However, in many of the present applications, the use of a leaded configuration is a requirement of the application. Further in accordance with the present subject matter, the exemplary embodiment of present FIGS. 6a through 6f discloses several lead arrangements of the present subject matter that can help to minimize such inherent detriment.

With reference to present FIGS. 3a through 3d (illustrating and representing a first exemplary embodiment, with various present exemplary alternative lead configurations, of the present subject matter), the exploded view of present FIG. 3a shows the main parts or components, including a holed lead frame 34 for both respective sides 30 and 32. Such side components 30 and 32 may, in some embodiments, be the same as the structures 20 and 22 of present FIG. 2a. The respective MLC components may individually be of the same type of layered construction as the structures represented in present FIGS. 1d and 1e. However, the terminations of the respective present subject matter MLC's, and the orientations of such terminations relative to the overall present configuration, are as depicted with reference to elements 36 of present FIG. 3a.

Once the components or parts of present FIG. 3a are fixtured or otherwise situated as to provide the present structure and arrangement as shown in present FIG. 3b, they may then per present subject matter either be soldered with high temperature solder, or brazed, or bonded together (generally presently preferred) using conductive epoxy. Such bonding approach not only provides the ability to withstand relatively high temperatures during subsequent board mounting, but also provides a degree of physical compliance that metallurgical joints do not. The cross-section view of present FIG. 3c (taken from the plane C-C′ of present FIG. 3b) represents an exemplary bonded area 33 of such particular bonded exemplary embodiment of the present subject matter.

Per further alternatives in accordance with the present subject matter, it should be understood and appreciated by those of ordinary skill in the art that the external leads can be re-formed for specific purposes or needs (such as surface mounting, better compliance, etc.) without deviating from the broader aspects of the present subject matter. Exemplary present alternative lead configurations as may variously be practiced include the respective exemplary lead configurations 31, 31′, and 31″ as represented with present FIG. 3d.

With certain applications, it is sometimes advantageous to provide individual leads to the parts or components. Present FIGS. 4a through 4e, respectively, illustrate different aspects and views of another exemplary embodiment of a low inductance, high rating device in accordance with the present subject matter, and with such respective or individual leads. The use of individual leads can become significant in at least two scenarios. The first is when the parts are very large. In such circumstances, any differences in the thermal coefficient of expansion (TCE) can be mitigated by dividing the long flag like portion that could otherwise create stress. In other instances or applications, the capacitor sections may be required to be individual capacitors so that the resulting part or device can function as an array.

Present FIG. 4a illustrates an exploded generally side and end perspective view of the major components of such a present exemplary embodiment, with individual or respective leads. FIG. 4b illustrates an assembled generally side and end perspective view of such major components, while FIG. 4c illustrates a cross-sectional view of the illustrated assembled device of FIG. 4b taken along section line D-D′ thereof. FIG. 4d illustrates a generally side and end perspective view of the assembled parts of present FIG. 4b once they are electrically joined. FIG. 4e illustrates a generally side and end perspective view of a completed example of such exemplary embodiment, with the resulting part (see 49 of present FIG. 4d) provided such that capacitor sections are configured as individual capacitors so that he part 49′ (FIG. 4e) can function as an array.

FIG. 4a illustrates such a present exemplary embodiment, with the respective MLC's 48 and the lead sets 40 and 42 shown in an exploded view. Once they are fixtured or otherwise situated in close proximity (as represented in present FIG. 4b), they may be secured, such as dipped in solder, or otherwise bonded with epoxy or brazing, as referenced above. If the parts are to be electrically isolated (as one alternative in accordance with the present subject matter), then separators 41 (as shown in FIG. 4e) may be one means provided. The material of such exemplary separator 41 must, of course, be able to withstand the subsequent bonding and environmental stresses of further expected processing and usage of the device.

FIG. 4c shows the cross-sectional view taken through the plane D-D′ of FIG. 4b, with bonding material 43 situated. In the alternative configuration of such exemplary embodiment as shown in FIG. 4d, the parts are electrically joined as in the previous examples, using bonding material 43 to produce the finished exemplary device 49. FIG. 4e represents alternative exemplary device 49′ when configured as individual capacitors. In such present exemplary configuration, separator 41 electrically and physically isolates the parts, while the bonding material 43′ only adheres the MLC's to the leads, and not to each other. In some cases, separator material 41 may be a material with relatively high thermal conductivity (for example, such as greater then 20 J/kg-K) to aid in heat dissipation.

The present subject matter provides yet further alternative features for even further reducing the subject inductance. FIG. 5a illustrates a generally side and end perspective view of two exemplary capacitor devices mounted on an exemplary circuit board in a generally known configuration. If it is desired to use the present subject matter for reducing the subject inductance of subject exemplary subject matter even further, various revisions and/or design changes are required. FIG. 5a illustrates the comparison between a so-called standard MLC 58′ and a relatively lower inductance MLC 58. Such representative parts are depicted as mounted on an exemplary circuit board 50. The images of the board cross-section illustrate representative exemplary buried circuits 52′ and 52, respectively associated with each type of respective device 58′ and 58. In the case of the standard MLC, the lands to which the terminals are soldered are typically connected by conductive vias to power and ground planes within the board. Often times, relatively little attention is paid to the specific structure or dimensions, because it does not matter for most instances, and because the locations of vias and buried conductors are determined by other expedients.

However, when the application needs indicate a desire to lower the subject inductance as much as possible, then the present subject matter is advantageous. In present FIG. 5a, circular loop 55′ is for the exemplary circuit 52′ of the standard MLC 58′ while circular loop 55 is for the exemplary circuit 52 of the relatively lower inductance MLC 58. Generally, the smaller such current loops are, the lower the overall inductance of the associated capacitor circuit. As can be appreciated in contemplating the representative standard device 58′, relatively little can be done to reduce circular loop 55′ thereof, and the corresponding inductance associated therewith. However, with careful design of the internal electrodes of the capacitor per the present subject matter, and corresponding attention paid by the user to the mounting scheme, loop 55 can be made relatively quite small, with corresponding beneficial effects on the subject inductance.

FIG. 5b illustrates a planar side view of respective exemplary internal electrode designs in accordance with the present subject matter and applicable in pertinent part to present FIG. 5a. FIG. 5c illustrates in partial shadow view a generally side and end perspective view of an exemplary arrangement of internal electrodes, such as represented in such present FIG. 5b, in accordance with the present subject matter. FIG. 5d illustrates a generally side and end perspective view of the assembled configuration of present FIG. 5c after such assembled device has been sintered in accordance with the present subject matter, while FIG. 5e illustrates a generally side and end perspective view of a completed exemplary embodiment of the subject matter of present FIGS. 5b through 5d in accordance with the present subject matter.

With the partial shadow view of FIG. 5c, a present exemplary arrangement of internal electrodes is revealed that benefits the reduced loop mechanism. FIG. 5b shows the specific design of each left (reference character 51) and right (reference character 51′) electrode layer pattern. Such pairs are built up into the MLC by alternating such patterns, and may be done so using manners and techniques well known in the art without requiring additional present discussion. Once completed, per the present subject matter, the parts are sintered. Their resulting appearance is represented by the illustrations of present FIG. 5d. Such electrodes 51 and 51′ are now respectively edge-exposed along what may be termed a side of the part, and the bottom thereof. An intentional gap 57 (see present FIGS. 5d and 5e) in accordance with the present subject matter defines the space between opposing electrodes, which is a significant present aspect with reference to relatively lowered inductance for this exemplary embodiment.

FIG. 5e shows the subject exemplary completed device 58 per present subject matter, with terminations 56 and 56′. The presence and location of gap 57 is highlighted to reflect its contribution regarding relatively low inductance of the present configuration.

Another non-trivial advantage of the present exemplary embodiment is the absence of termination on the corners 59 and on the side 53. Such two resulting aspects of the present exemplary embodiment allow the resulting present parts to be placed in more intimate contact, as will be appreciated even further in conjunction with the description herein regarding the subject matter of present FIGS. 6a through 6f. While such precision termination can be done with careful thick film techniques, presently preferred methodologies may be based on the electroless copper process, as described in U.S. Pat. Nos. 7,152,291; 7,154,374; and 7,177,137, the complete disclosures (including drawings) of which are fully incorporated herein by reference, for all purposes.

FIGS. 6a through 6f, respectively, illustrate different aspects and views of another exemplary embodiment of a low inductance, high rating device in accordance with the present subject matter, particularly reflecting how the relatively lower inductance MLC subject matter described with reference to FIGS. 5a through 5e may lend itself to an improved stacked-capacitor type package. Note that the aspect ratio of representative capacitor 58 has been changed simply for the sake of clarity of illustration.

Present FIG. 6a illustrates an exploded generally side and end perspective view of the major components of such exemplary embodiment, with FIG. 6b illustrating an assembled generally side and end perspective view of such major components, and with FIG. 6c illustrating a cross-sectional view of the illustrated assembled device of FIG. 6b taken along section line E-E′ thereof. FIG. 6d also illustrates a cross-sectional view of an assembled device in accordance with the present subject matter similar to the view of present FIG. 6c but illustrating a present alternative lead configuration thereof. FIG. 6e illustrates an enlarged portion of particular exemplary features shared in common by the alternative configurations of present FIGS. 6c and 6d. FIG. 6f illustrates a generally side and end perspective view of a completed example of such exemplary embodiment.

The exploded part assembly illustrated with FIG. 6a shows device 58 as being situated between respective individualized leads 60 and 62. As represented with such FIG. 6a illustration, and as will be appreciated by those of ordinary skill in the art, the absence of electrically conductive material on either of the faces 53 of the capacitors 58 or on the edges 59 will allow the MLC's to be placed in contact with each other without concern for shorting.

FIG. 6a also illustrates a significant change to the lead configuration for such present exemplary embodiment of the present subject matter. Specifically, leads 60 and 62 have introduced therein a tab-like structure 64 which can be formed by perforating the lead along three sides of a rectangle, and bending the metal flag down to form a small shelf. Such tab provides three respective advantages or expedients per the present subject matter. First, such tabs respectively serve to more precisely place the lead. A second advantage is that the lead to capacitor strength is improved. A third resulting advantage is that each respective tab serves to promote lower resistance and inductance.

The exemplary tabs 64 may have many configurations, in accordance with the present subject matter, as will be understood by those of ordinary skill in the art. For example, the smaller portion thereof can remain vertical, with the larger portion bent over. Also, the lead could be simply split down the middle, with half of it bent. Still further, the lead can be a different shape altogether, as represented in present FIG. 6d. Furthermore, the lead itself could be made of different materials, for example: a copper alloy if low ESR were desired, or a resistive alloy if controlled ESR were important, or a fuse material if such protection were warranted, or a magnetic material if the parts were to be handled by magnetic holders, and so forth.

FIG. 6b depicts the exemplary assemblage ready for bonding, with a cross-section of plane E-E′ represented by the illustrations of present FIG. 6c which shows the cross section through that area. Exemplary internal electrode 51 is represented in FIG. 6c so as to illustrate the relationship of the electrode design and placement to the new lead structure (inclusive of leads 60 and 62, and optionally inclusive of tabs 64). Bonding material 63 (see also FIG. 6e) joins the leads 60 and 62 electrically and physically to the exemplary termination. Such relationship is shown in an enlarged isolated view in FIG. 6e (which represents corresponding subject matter in both of the alternative embodiments of present FIGS. 6c and 6d). As represented in FIG. 6e, electrode 51 is electrically tied to termination 56, which is in turn connected via solder 63 to lead 60.

In accordance with the present subject matter, an even relatively lower inductance may be provided by reconfiguring the leads as shown in FIG. 6d. Such bending of the leads 60 and 62 to the smaller spacing will allow a smaller current loop, and less thermal stress because of a reduction in DNP, as referenced above in conjunction with disclosure of the present subject matter.

FIG. 6f illustrates an essentially completed device 69 in accordance with the present exemplary embodiment (inclusive of the FIG. 6c exemplary lead configuration). When the leads are configured as separate parts, the leads can form an interdigitated arrangement (or commonly referenced as IDC, for example, as represented in U.S. Pat. No. 5,880,925), so that the currents cancel, giving another reduction in inductance. The disclosure of U.S. Pat. No. 5,880,925 is fully incorporated herein by reference, and for all purposes.

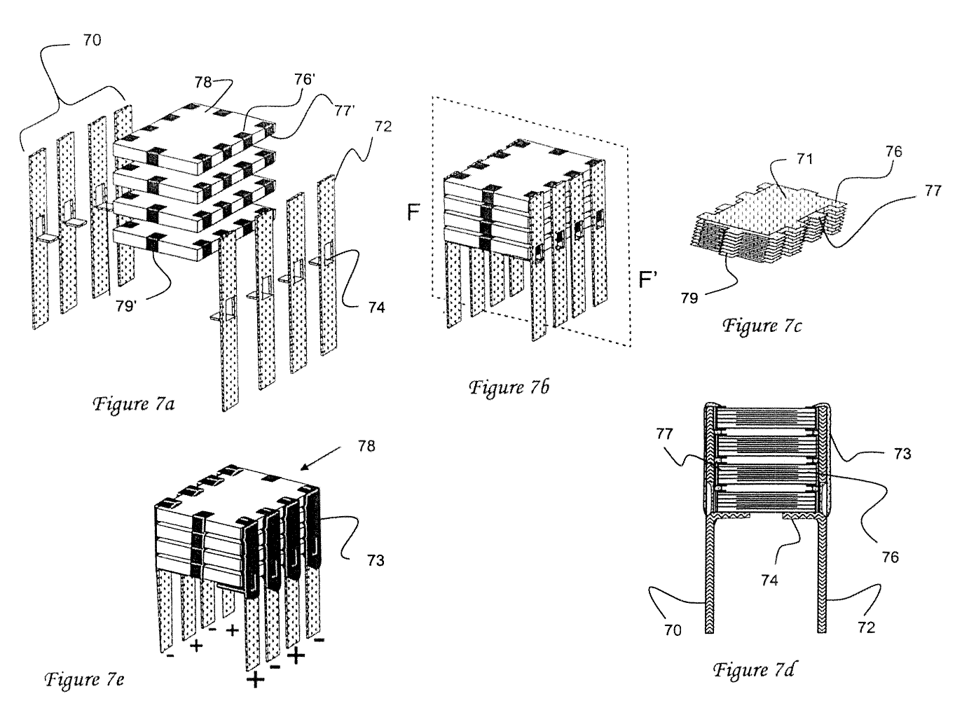

The common low inductance MLC configuration or design generally known as an IDC (as described in the above-referenced U.S. Pat. No. 5,880,925) may also be incorporated in the above-referenced SMPS product. When so used per present subject matter, it will provide another means or configuration for low inductance in the presently discussed relatively larger parts. FIGS. 7a through 7e, respectively, illustrate different aspects and views of still another exemplary embodiment of a low inductance device in accordance with the present subject matter.

Present FIG. 7a shows an exploded generally side and end perspective view of the present subject matter similar in part to that of present subject matter of FIG. 6a, with lead tabs 74 of respective leads 70 and 72 folded down to support and make a low resistance/low inductance connection to the exemplary IDC generally 78. Terminations 76′, 77′, and 79′ of FIG. 7a cover tab extensions otherwise discussed herein. End terminations 79′ are provided for easier testing during manufacture, and for improved thermal dissipation during use. Present FIG. 7b is an assembled generally side and end perspective view of the subject major components similar to the subject matter of present FIG. 7a but illustrating such configuration in an assembled condition thereof prior to bonding.

The internal electrode construction of the exemplary IDC 78 is shown in FIG. 7c in perspective view. In addition, such view is slightly skewed to better illustrate the details of construction. Electrode 71 has tab extensions 76 which exit the component at all four sides, referenced with extensions 76 and 77 on the sides, and 79 on the ends.

FIG. 7d illustrating a cross-sectional view of the illustrated exemplary assembled device of present FIG. 7b taken along section line F-F′ thereof. As shown, electrode tabs 77 mate with the opposite polarity to pin 70 as electrode tab 76 is mated to pin 72. The above-referenced tab support 74 provides a ledge-like structure to hold the IDC stack during soldering, and to permit lower resistance. Bonding or soldering material 73 (see also FIG. 7e) joins the leads 70 and 72 electrically and physically to the exemplary termination. Such relationship is shown in a nearly completed device in FIG. 7e, after the soldering or bonding operation. The illustrated polarity signs demonstrate the interdigitated nature of the connections.

Exemplary embodiments of the present subject matter may be altered in many ways without departing from the spirit of the disclosure. For example, different devices, such as resistors, inductors, or varistors, may be practiced instead of a capacitor. One particular exemplary such combination may include inserting a varistor in parallel with three capacitors to provide bulk capacitance with overvoltage protection. Still further, different dielectric types can be used to provide multiple Curie points and a more stable temperature versus capacitance curve. Different value capacitors may be combined, so as to provide multiple resonances, and a broader S21 (forward voltage gain) response.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A low inductance multilayer electronic component configured for mounting on a circuit board having an associated circuit, comprising:
a plurality of first electrode layers, each first electrode layer respectively having a first conductive layer extending to at least a portion of one edge of each said respective first electrode layer;
a plurality of second electrode layers alternately stacked with said plurality of first electrode layers, each second electrode layer respectively having a second conductive layer extending to at least a portion of one edge of each said respective second electrode layer;
a first conductive termination layer covering a portion of said at least one edge of each said respective first electrode layer and electrically connecting said first conductive layer of each of said plurality of first electrode layers;
a second conductive termination layer covering a portion of said at least one edge of each said respective second electrode layer and electrically connecting said second conductive layer of each of said plurality of second electrode layers; and
a pair of lead frame elements respectively connected structurally and electrically with said first and second conductive termination layers, and configured so that said first and second electrode layers are in a vertical position relative to an associated circuit board;
whereby a minimum current loop area is formed with said plurality of first and second electrode layers and the associated circuit of an associated circuit board, so as correspondingly reduce inductance of said multilayer electronic component.

2. A low inductance multilayer electronic component as in claim 1, wherein said plurality of first and second electrode layers are configured so as to form said component as one of a capacitor, resistor, varistor, and inductor.

3. A low inductance multilayer electronic component as in claim 1, wherein: said plurality of first and second electrode layers include respective dielectric layers and are configured in respective sets so as to form an array of respective capacitors.

4. A low inductance multilayer electronic component as in claim 3, further comprising:
a plurality of respective first and second conductive termination layers, respectively associated with said respective capacitors; and
a plurality of separators between said respective capacitors, for electrically isolating said respective capacitors;
wherein said pair of lead frame elements respectively include individual leads associated in pairs with said respective capacitors.

5. A low inductance multilayer electronic component as in claim 4, wherein said separators comprise materials having relatively high thermal conductivity.

6. A low inductance multilayer electronic component as in claim 3, wherein said respective capacitors have predetermined respective capacitance values.

7. A low inductance multilayer electronic component as in claim 1, wherein said pair of lead frame elements respectively comprise predetermined shapes, adapted for particular uses of said component.

8. A low inductance multilayer electronic component as in claim 1, wherein each of said pair of lead frame elements respectively includes tabs which comprise predetermined shapes and which establish designated contact areas for said termination layers.

9. A low inductance multilayer electronic component as in claim 1, wherein each of said pair of lead frame elements respectively includes a plurality of holes for receipt of connecting material therein.

10. A low inductance multilayer electronic component as in claim 1, further in combination with a circuit board having an associated circuit, with said pair of lead frame elements secured to said circuit board, and with said termination layers electrically connected with said associated circuit of said circuit board.

11. A low inductance multilayer electronic component as in claim 1, wherein each of said plurality of first and second electrode layers include respective dielectric layers, collectively forming a multilayer capacitor having interdigitated internal electrode layers.

12. A low inductance multilayer electronic component as in claim 1, wherein said first and second conductive termination layers are configured so as to leave exposed at least edges and a side of said electronic component, to facilitate handling and positioning thereof relative to other components.

13. A low inductance multilayer electronic component as in claim 1, wherein:
each of said plurality of first electrode layers respectively comprises a first dielectric layer having first and second surfaces thereof bounded by four edges and with each of said respective first conductive layers thereof covering a portion of said first surface of said first dielectric layer and extending to at least a portion of one edge of said first dielectric layer; and
each of said plurality of second electrode layers respectively comprises a second dielectric layer having first and second surfaces thereof bounded by four edges and with each of said respective second conductive layers thereof covering a portion of said first surface of said second dielectric layer and extending to at least a portion of one edge of said second dielectric layer.

14. A low inductance multilayer electronic capacitor, configured for mounting on a circuit board having an associated circuit, comprising:
a plurality of first electrode layers, each first electrode layer comprising a first dielectric layer having first and second surfaces thereof and a first conductive layer covering a portion of said first surface of said first dielectric layer and extending to at least a portion of one edge of said first dielectric layer;
a plurality of second electrode layers alternately stacked with said plurality of first electrode layers, each second electrode layer comprising a second dielectric layer having first and second surfaces thereof and a second conductive layer covering a portion of said first surface of said second dielectric layer and extending to at least a portion of one edge of said second dielectric layer, the second conductive layer formed as a mirror image of the first conductive layer;
a first conductive termination layer covering a portion of said at least one edge of said first electrode layer and electrically connecting said first conductive layer of each of said plurality of first electrode layers;
a second conductive termination layer covering a portion of said at least one edge of said second electrode layer and electrically connecting said second conductive layer of each of said plurality of second electrode layers; and
a pair of lead frame elements respectively connected structurally and electrically with said first and second conductive termination layers, and configured so that said first and second electrode layers are in a vertical position relative to an associated circuit board;
whereby a minimum current loop area is formed with said plurality of first and second electrode layers and the associated circuit of an associated circuit board, so as correspondingly reduce inductance of said multilayer electronic capacitor.

15. A low inductance multilayer electronic capacitor as in claim 14, wherein:
said plurality of first and second electrode layers are configured in respective sets so as to form an array of respective capacitors; and
further comprising a plurality of respective first and second conductive termination layers, respectively associated with said respective capacitors; and
a plurality of separators between said respective capacitors, for electrically isolating said respective capacitors;
wherein said pair of lead frame elements respectively include individual leads associated in pairs with said respective capacitors.

16. A low inductance multilayer electronic capacitor as in claim 15, wherein said respective capacitors have predetermined respective capacitance values.

17. A low inductance multilayer electronic capacitor as in claim 14, wherein said pair of lead frame elements respectively comprise predetermined shapes, adapted for particular installations of said capacitor.

18. A low inductance multilayer electronic capacitor as in claim 14, wherein each of said pair of lead frame elements respectively includes tabs which comprise predetermined shapes and which establish designated contact areas for said termination layers.

19. A low inductance multilayer electronic capacitor as in claim 14, wherein each of said pair of lead frame elements respectively includes a plurality of holes for receipt of connecting material therein.

20. A low inductance multilayer electronic capacitor as in claim 14, further in combination with a circuit board having an associated circuit, with said pair of lead frame elements secured to said circuit board, and with said termination layers electrically connected with said associated circuit of said circuit board.

21. A low inductance multilayer electronic capacitor as in claim 14, wherein said first and second conductive termination layers are configured so as to leave exposed at least edges and a side of said electronic capacitor, to facilitate handling and positioning thereof relative to other components.

22. A low inductance multicomponent interdigitated electronic capacitor, configured for mounting on a circuit board having an associated circuit, comprising:
a plurality of first electrode layers, each first electrode layer comprising a first dielectric layer having first and second surfaces thereof and a first conductive layer covering a portion of said first surface of said first dielectric layer and extending in a plurality of first termination tabs to at least one edge of said first dielectric layer;
a plurality of second electrode layers alternately stacked with said plurality of first electrode layers, each second electrode layer comprising a second dielectric layer having first and second surfaces thereof and a second conductive layer covering a portion of said first surface of said second dielectric layer and extending in a plurality of second termination tabs to at least one edge of said second dielectric layer, the second conductive layer formed as a mirror image of the first conductive layer;
at least two respective sets of said plurality of first and second electrode layers, configured for forming respective interdigitated capacitor components;
a set of first conductive termination layers covering respectively said first termination tabs of said at least one edge of said first electrode layer and electrically connecting said first conductive layer of each of said plurality of first electrode layers;
a set of second conductive termination layers covering respectively said second termination tabs of said at least one edge of said second electrode layer and electrically connecting said second conductive layer of each of said plurality of second electrode layers; and
a pair of respective sets of lead frame elements respectively connected structurally and electrically with said first and second sets of conductive termination layers, and configured so that said first and second electrode layers are in a parallel position relative to an associated circuit board, each of said respective lead frame elements having a lead tab directly contacting and supporting said respective conductive termination layers, whereby a low resistance and low inductance connection is formed with said interdigitated capacitor components.

23. A low inductance multicomponent interdigitated electronic capacitor as in claim 22, further in combination with a circuit board having an associated circuit, with said pair of respective sets of lead frame elements secured to said circuit board, and with said termination layers electrically connected with said associated circuit of said circuit board.

24. Methodology for making a low inductance multilayer electronic component configured for mounting on a circuit board having an associated circuit, comprising:
providing a plurality of first electrode layers, each first electrode layer respectively having a first conductive layer extending to at least a portion of one edge of each such respective first electrode layer;
providing a plurality of second electrode layers alternately stacked with such plurality of first electrode layers, each second electrode layer respectively having a second conductive layer extending to at least a portion of one edge of each such respective second electrode layer;
covering a portion of such at least one edge of each such respective first electrode layer with a first conductive termination layer which electrically connects such first conductive layer of each of such plurality of first electrode layers;
covering a portion of such at least one edge of each such respective second electrode layer with a second conductive termination layer which electrically connects such second conductive layer of each of such plurality of second electrode layers; and
providing a pair of lead frame elements respectively connected structurally and electrically with such first and second conductive termination layers, and configured so that such first and second electrode layers are in a vertical position relative to an associated circuit board, thereby forming a minimum current loop area with such plurality of first and second electrode layers and the associated circuit of an associated circuit board, so as correspondingly reduce inductance of such multilayer electronic component.

25. Methodology as in claim 24, further including selectively configuring such plurality of first and second electrode layers so as to form such component as one of a capacitor, resistor, varistor, and inductor.

26. Methodology as in claim 24, further including:
providing such plurality of first and second electrode layers with respective dielectric layers;
configuring such dielectric layers in respective sets so as to form an array of respective capacitors;
providing a plurality of respective first and second conductive termination layers, respectively associated with such respective capacitors;
providing a plurality of separators between such respective capacitors, for electrically isolating such respective capacitors; and
providing such pair of lead frame elements respectively with individual leads associated in pairs with such respective capacitors.

27. Methodology as in claim 26, further including providing such separators comprised of materials having relatively high thermal conductivity.

28. Methodology as in claim 26, further including providing such respective capacitors with predetermined respective capacitance values.

29. Methodology as in claim 24, further including providing such pair of lead frame elements respectively with predetermined shapes, adapted for particular uses of such component.

30. Methodology as in claim 24, further including providing each of such pair of lead frame elements respectively with tabs which comprise predetermined shapes and which establish designated contact areas for such termination layers.

31. Methodology as in claim 24, further including:
providing each of such pair of lead frame elements respectively with a plurality of holes; and
securing bonding material in such lead frame element holes.

32. Methodology as in claim 24, further including:
providing a circuit board having an associated circuit; and
securing such pair of lead frame elements to such circuit board, with such termination layers electrically connected with such associated circuit of such circuit board.

33. Methodology as in claim 24, further including selectively configuring such first and second conductive termination layers so as to leave exposed at least edges and a side of such electronic component, to facilitate handling and positioning thereof relative to other components.

34. Methodology as in claim 24, wherein the step of providing a pair of lead frame elements respectively connected structurally and electrically with such first and second conductive termination layers includes one of soldering, brazing, and bonding with conductive epoxy such lead frame elements to such termination layers.

35. Methodology as in claim 24, wherein the steps of covering respective electrode layers with termination layers includes electroless copper deposition of such termination layers.

36. Methodology for making a low inductance multilayer electronic capacitor, configured for mounting on a circuit board having an associated circuit, comprising:
providing a plurality of first electrode layers, each first electrode layer comprising a first dielectric layer having first and second surfaces thereof and a first conductive layer covering a portion of such first surface of such first dielectric layer and extending to at least a portion of one edge of such first dielectric layer;
providing a plurality of second electrode layers alternately stacked with such plurality of first electrode layers, each second electrode layer comprising a second dielectric layer having first and second surfaces thereof and a second conductive layer covering a portion of such first surface of such second dielectric layer and extending to at least a portion of one edge of such second dielectric layer, the second conductive layer formed as a mirror image of the first conductive layer;
covering a portion of such at least one edge of such first electrode layer with a first conductive termination layer which electrically connects such first conductive layer of each of such plurality of first electrode layers;
covering a portion of such at least one edge of such second electrode layer with a second conductive termination layer which electrically connects such second conductive layer of each of such plurality of second electrode layers; and
providing a pair of lead frame elements respectively connected structurally and electrically with such first and second conductive termination layers, and configured so that such first and second electrode layers are in a vertical position relative to an associated circuit board, thereby forming a minimum current loop area with such plurality of first and second electrode layers and the associated circuit of an associated circuit board, so as correspondingly reduce inductance of such multilayer electronic component.

37. Methodology as in claim 36, further including:
selectively configuring such plurality of first and second electrode layers in respective sets so as to form an array of respective capacitors;
providing a plurality of respective first and second conductive termination layers, respectively associated with such respective capacitors; and
providing a plurality of separators between such respective capacitors, for electrically isolating such respective capacitors; and
providing such pair of lead frame elements respectively with individual leads associated in pairs with such respective capacitors.

38. Methodology as in claim 37, further including providing such respective capacitors with predetermined respective capacitance values.

39. Methodology as in claim 36, further including providing such pair of lead frame elements respectively with predetermined shapes, adapted for particular installations of such capacitor.

40. Methodology as in claim 36, further including providing each of such pair of lead frame elements respectively with tabs which comprise predetermined shapes and which establish designated contact areas for such termination layers.

41. Methodology as in claim 36, further including:
providing each of such pair of lead frame elements respectively with a plurality of holes; and
securing bonding material in such lead frame element holes.

42. Methodology as in claim 36, further including:
providing a circuit board having an associated circuit;
securing such pair of lead frame elements to such circuit board, with such termination layers electrically connected with such associated circuit of such circuit board.

43. Methodology as in claim 36, further including selectively configuring such first and second conductive termination layers so as to leave exposed at least edges and a side of such electronic capacitor, to facilitate handling and positioning thereof relative to other components.

44. Methodology as in claim 36, wherein the steps of covering respective electrode layers with termination layers includes electroless copper deposition of such termination layers.
